(19) United States
(12) Patent Application Publication
(10) Pub. No.: US 2009/0261073 A1
(43) Pub. Date: Oct. 22, 2009

(54) SYSTEM AND METHODS OF USING VARIABLE WAVEFORM AC ARC WELDING TO ACHIEVE SPECIFIC WELD METAL CHEMISTRIES

(75) Inventor: Kenneth MUI, Coquitlam (CA)

Correspondence Address: HAHN LOESER / LINCOLN, ONE GOJO PLAZA, SUITE 300, AKRON, OH, 44311-1076, US

(73) Assignee: LINCOLN GLOBAL, INC., City of Industry, CA (US)

(21) Appl. No.: 12/107,100

(22) Filed: Apr. 22, 2008

(51) Int. Cl. B23K 9/18; B23K 9/04

(52) U.S. Cl. 219/73; 219/76.14

(57) ABSTRACT

A system and methods for overlaying metal in an arc welding operation to achieve a resultant weld metal chemistry of the resultant weld metal. Various combinations of DC+/DC− balance settings and DC offset settings for an AC Waveform of an arc welding overlaying process may be correlated to resultant chemistries of resultant weld metals. The correlations may be subsequently used to select a combination of a balance setting and an offset setting for an AC waveform that results in a desired weld metal chemistry for an arc welding overlaying process using an overlay metal and a base substrate metal.

### TECHNICAL FIELD

Certain embodiments relate to overlaying metal in a welding operation. More particularly, certain embodiments relate to overlaying metal in an arc welding operation to achieve a resultant weld metal chemistry.

### BACKGROUND

Arc welding is a group of welding processes that produces coalescence of metals by heating them with an arc, with or without the application of pressure, and with or without the use of filler material. Overlaying is the process of welding a layer or layers of material to a surface to obtain desired properties or dimensions, as opposed to making a joint. Such overlaying may be performed, for example, to improve corrosion resistance, heat resistance, or wear resistance of a substrate surface. The term “overlaying” is used herein as a generic term that encompasses “surfacing”, “hard-facing”, “cladding”, or any method that entails depositing a first molten metal onto a second metal base or substrate using arc welding.

Submerged arc welding (SAW) is an arc welding process that produces coalescence of metals by heating them with an arc or arcs between a bare metal electrode or electrodes and the workpieces. The arc and molten metal are shielded by a blanket of granular, fusible material on the workpieces. Pressure is not used and filler metal is obtained from the electrode and sometimes from a supplemental source (welding rod, flux, or metal granules).

The distinguishing feature of SAW is the granular material which covers the weld area and prevents arc radiation, sparks, spatter, and fumes from escaping. Flux provides a slag which protects the weld metal as it cools, deoxidizes and refines the weld metal, insulates the weld to reduce the cooling rate, and helps shape the weld contour. In overlaying, the SAW process provides increased welding speeds but requires precautions to prevent dilution of the weld deposit with the base metal.

Further limitations and disadvantages of conventional, traditional, and proposed approaches will become apparent to one of skill in the art, through comparison of such approaches with embodiments of the present invention as set forth in the remainder of the present application with reference to the drawings.

### BRIEF SUMMARY

An embodiment of the present invention comprises a method to correlate welding power source and controller waveform parameters to a resultant weld metal chemistry in an arc welding overlay application. The method includes selecting an initial AC waveform on a welding power source and controller corresponding to a desired are welding overlay application. The initial AC waveform provides a frequency of operation, a current range of operation, and a voltage range of operation that results in a desired productivity. The method also includes selecting a balance setting on the welding power source and controller to modify a DC+/DC− balance of the selected waveform and selecting an offset setting on the welding power source and controller to modify a DC offset of the selected waveform. The method further includes performing an arc welding overlay operation by overlaying a first metal onto a second metal substrate using the modified AC waveform provided by the welding power source and controller. The method also includes determining a resultant chemistry of a resultant overlay weld metal of the overlay operation. The method further includes recording the initial AC waveform, the balance setting, the offset setting, and the resultant chemistry for the overlay operation. Various steps of the method may be repeated until various combinations of the balance setting and the offset setting have been used to determine a correlated chemistry. The resultant chemistry may correspond to a particular iron content of the resultant overlay weld metal, a particular ratio of iron content to nickel content of said overlay weld metal, a particular ferrite number (FN) of the resultant overlay weld metal, a particular chromium carbide content of the resultant overlay weld metal, and/or a particular manganese content of the resultant overlay weld metal. In accordance with an embodiment, the first metal content may comprise a nickel alloy and the second metal substrate may comprise carbon steel. In accordance with another embodiment, the first metal may comprise a nickel and chromium alloy and the second metal substrate may comprise carbon steel. In accordance with a further embodiment, the first metal may comprise an austenitic stainless steel and the second metal substrate may comprise carbon steel. In accordance with an embodiment, the arc welding overlay operation is a submerged arc welding (SAW) overlay operation.

Another embodiment of the present invention comprises a method to perform an arc welding overlay operation to achieve a desired overlay weld metal chemistry. The method includes selecting an initial AC waveform on a welding power source and controller corresponding to a desired arc welding overlay application. The initial AC waveform provides a frequency of operation, a current range of operation, and a voltage range of operation that results in a desired productivity. The method also includes selecting a combination of a balance setting and an offset setting on the welding power source and controller to modify a DC+/DC− balance and a DC offset of the selected waveform, wherein the modified waveform correlates to the desired overlay weld metal chemistry. The method further includes performing an arc welding overlay operation by welding a first metal onto a second metal substrate using the modified AC waveform provided by the welding power source and controller to form an overlay weld metal having the desired overlay weld metal chemistry. The desired overlay weld metal chemistry may correspond to a particular iron content of the resultant overlay weld metal, a particular ratio of iron content to nickel content of said overlay weld metal, a particular ferrite number (FN) of the resultant overlay weld metal, a particular chromium carbide content of the resultant overlay weld metal, and/or a particular manganese content of the resultant overlay weld metal. In accordance with an embodiment, the first metal comprises a nickel alloy and the second metal substrate comprises carbon steel. In accordance with another embodiment, the first metal comprises a nickel and chromium alloy and the second metal substrate comprises carbon steel. In accordance with a further embodiment, the first metal comprises an austenitic stainless steel and the second metal substrate comprises carbon steel. In accordance with an embodiment, the arc welding overlay operation is a submerged arc welding (SAW) overlay operation.

A further embodiment of the present invention comprises an arc welding system. The arc welding system includes means for directing a first metal electrode toward a second metal substrate during an arc welding overlay operation of overlaying the first metal electrode onto the second metal substrate. The system also includes means for supplying the first metal electrode to the means for directing the first metal electrode toward the second metal substrate at a selected wire feed speed during the arc welding overlay operation. The system further includes means for providing electrical power in the form of a selected arc welding AC waveform between the first metal electrode and the second metal substrate during the arc welding overlay operation to form an arc between the first metal electrode and the second metal substrate such that the selected arc welding AC waveform results in a desired productivity during the arc welding overlay operation. The system also includes means for selecting and applying a combination of a DC+/DC− balance setting and a DC offset setting to the selected arc welding AC waveform, wherein the combination has been previously correlated to a specific chemistry of an overlay weld metal resulting from the arc welding overlay operation using the arc welding system. The specific chemistry of the resulting overlay weld metal may correspond to a particular iron content of the resultant overlay weld metal, a particular ratio of iron content to nickel content of said overlay weld metal, a particular ferrite number (FN) of the resultant overlay weld metal, a particular chromium carbide content of the resultant overlay weld metal, and/or a particular manganese content of the resultant overlay weld metal. The first metal electrode may be, for example, a nickel alloy, a nickel and chromium alloy, or an austenitic stainless steel. The second metal substrate may be a carbon steel, for example. The arc welding system may be a submerged arc welding (SAW) system, for example.

These and other features of the claimed invention, as well as details of illustrated embodiments thereof, will be more fully understood from the following description and drawings.

### BRIEF DESCRIPTION OF THE DRAWINGS

FIG. 1 illustrates an exemplary embodiment of an arc welding system used in overlaying welding processes;

FIG. 2A illustrates the concept of DC+/DC− balance of an AC welding waveform;

FIG. 2B illustrates the effect of the DC+/DC− balances of FIG. 2A on penetration and deposition of an overlaid weld metal onto a substrate metal;

FIG. 3A illustrates the concept of DC offset of an AC welding waveform;

FIG. 3B illustrates the effect of the DC offsets of FIG. 3A on penetration and deposition of an overlaid weld metal onto a substrate metal;

FIG. 4 is a flowchart of an exemplary embodiment of a method to correlate welding power source and controller waveform parameters to a resultant weld metal chemistry in an arc welding overlay application; and

FIG. 5 is a flowchart of an exemplary embodiment of a method to perform an arc welding overlay operation to achieve a desired overlay weld metal chemistry.

### DETAILED DESCRIPTION

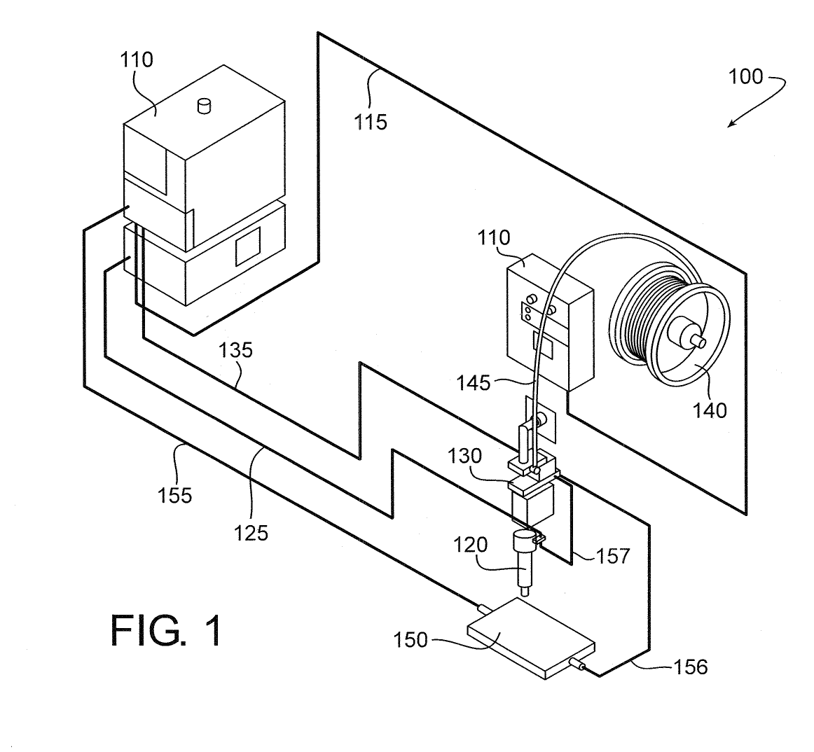

FIG. 1 illustrates an exemplary embodiment of an arc welding system 100 used in overlaying welding processes. The arc welding system 100 includes a welding power source and controller 110, a welding nozzle, gun, or torch 120, a wire feeder 130, and a wire reel source 140. In FIG. 1, the welding power source and controller 110 is shown as two devices connected by a control cable 115. However, in accordance with another embodiment, the welding power source and controller 110 may be fully integrated into a single unit. An electrode wire 145 is fed from the wire reel source 140 to the wire feeder 130 and into the nozzle 120.

The welding power source and controller 110 is operationally connected to the wire feeder 130 via a wire feeder control cable 135. The welding power source and controller 110 is operationally connected to the welding nozzle 120 via an electrode cable 125. A workpiece 150 to be overlaid is operationally connected to the welding power source and controller 110 via a work cable 155. A work sense lead 156 may be operationally connected between the workpiece 150 and the wire feeder 130. Similarly, an electrode sense lead 157 may be operationally connected between the welding head and nozzle 120 and the wire feeder 130. In accordance with an embodiment of the present invention, the arc welding system 100 is a submerged arc welding (SAW) system.

The welding power source and controller 110 provides the welding power, in the form of AC voltage and current waveforms or steady DC voltage and current, via the cables 125 and 155 to form an arc between the electrode wire 145 (fed through the nozzle 120 from the wire feeder 130) and the workpiece 150. In accordance with certain embodiments of the present invention, AC voltage and current waveforms provide the energy to overlay a weld metal (i.e., the wire 145) onto a substrate metal 150. Various characteristics of the AC waveform will determine various resultant weld overlay characteristics such as penetration and deposition. Such various AC waveform characteristics include current, voltage, balance, and offset which are elaborated upon hereinafter. Even though exemplary AC waveforms are illustrated herein as “square” waveforms, the AC waveforms may take many other shapes including, for example, sine waveforms and triangular waveform, in accordance with various embodiments of the present invention.

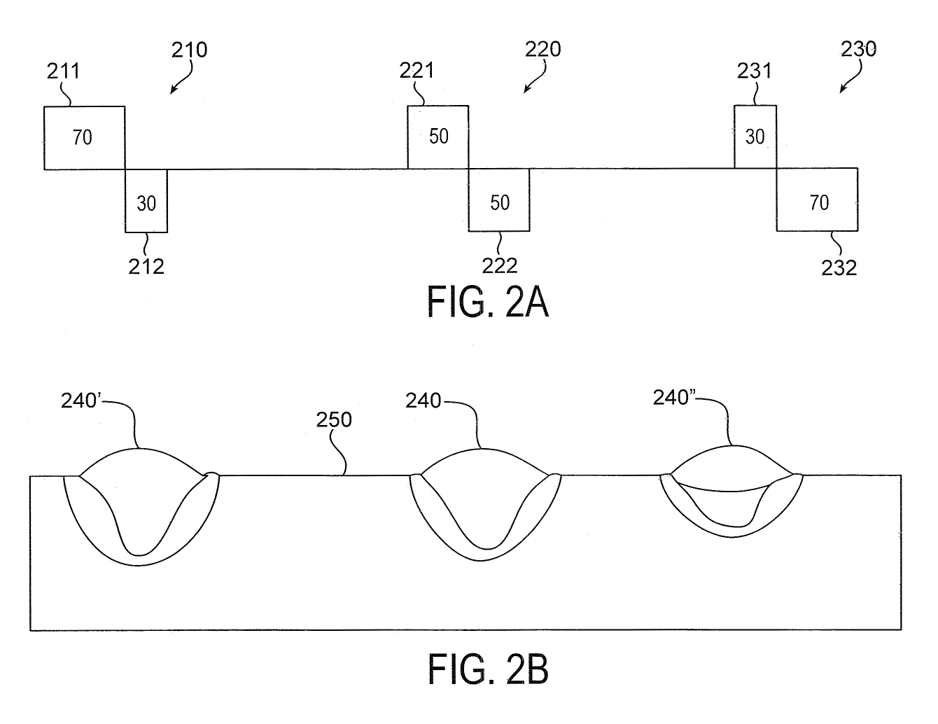

FIG. 2A illustrates the concept of DC+/DC− balance of an AC welding waveform. FIG. 2B illustrates the effect of the DC+/DC− balances of FIG. 2A on penetration and deposition of an overlaid weld metal 240 onto a substrate metal 250. The term “DC+/DC− balance” as used herein refers to the percentage of time the AC waveform exhibits a positive current portion versus the time the AC waveform exhibits a negative current portion.

For example, FIG. 2A shows one cycle of each of three AC waveforms 210-230, each balanced in a different manner. The AC waveform 210 is balanced such that the positive DC+ portion 211 of the AC waveform 210 encompasses 70% of the AC waveform 210, and the negative DC− portion 212 of the AC waveform 210 encompasses 30% of the AC waveform 210. The AC waveform 220 is balanced such that the positive DC+ portion 221 of the AC waveform 220 encompasses 50% of the AC waveform 220, and the negative DC− portion 222 of the AC waveform 220 encompasses 50% of the AC waveform 210. The AC waveform 230 is balanced such that the positive DC+ portion 231 of the AC waveform 230 encompasses 30% of the AC waveform 210, and the negative DC− portion 232 of the AC waveform 230 encompasses 70% of the AC waveform 230.

Referring to FIG. 2B, the AC waveform 220 exhibits a DC+/DC− 50/50 balance and results in a resultant overlay weld metal 240 having certain penetration and deposition characteristics. Penetration is the distance that the weld metal 240 extends into the substrate or base metal 250. Deposition is the amount of weld metal 240 deposited in a unit amount of time. It is assumed for discussion herein that the maximum positive current amplitude and the maximum negative current amplitude of the three waveforms is the same, as is the period and frequency of each waveform.

The AC waveform 210 exhibits a DC+/DC− 70/30 balance and results in an overlay weld metal 240′ having more penetration and less deposition than that of the weld metal 240 resulting from the AC waveform 220. Furthermore, waveform 230 exhibits a DC+/DC− 30/70 balance and results in an overlay weld metal 240″ having less penetration and more deposition than that of the weld metal 240 resulting from the AC waveform 220. Therefore, it may be seen that more DC+ balance results in more penetration and less deposition, whereas more DC− balance results in less penetration and more deposition.

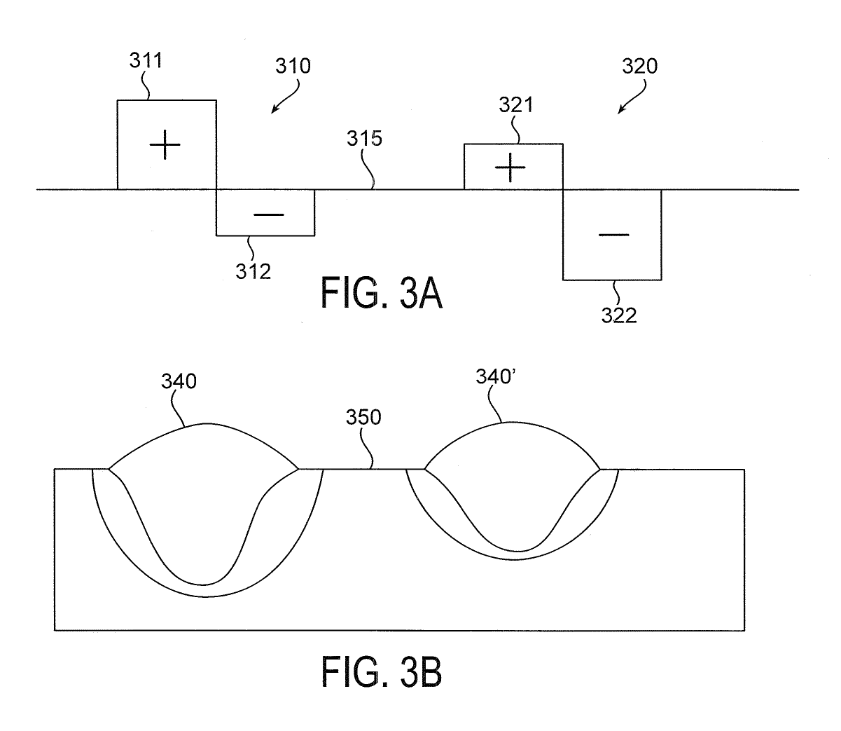

FIG. 3A illustrates the concept of DC offset of an AC welding waveform. FIG. 3B illustrates the effect of the DC offsets of FIG. 3A on penetration and deposition of an overlaid weld metal 340 onto a substrate metal 350. The term “DC offset” as used herein refers to a shift (positive or negative) in amplitude (e.g., current) of the entire AC welding waveform. The shift may be expressed as a percentage of the peak-to-peak current (e.g., +15% or −10%).

For example, in the waveforms of FIG. 2A, there is no DC offset or, in other words, the DC offset is zero. That is, the magnitude of the peak positive amplitude of the waveform is the same as the magnitude of the peak negative amplitude of the waveform. However, FIG. 3A shows one cycle of each of two AC waveforms 310-320, each having a different DC offset. The AC waveform 310 has a positive DC offset such that the magnitude of the peak positive amplitude 311 of the AC waveform 310 is greater than the magnitude of the peak negative amplitude 312 of the AC waveform 310 with respect to, for example, a zero current reference 315. The AC waveform 320 has a negative DC offset such that the magnitude of the peak positive amplitude 321 of the AC waveform 320 is less than the magnitude of the peak negative amplitude 322 of the AC waveform 320 with respect to, for example, the zero current reference 315.

Referring to FIG. 3B, the AC waveform 310, having a positive DC offset, results in an overlay weld metal 340 having more penetration into the substrate metal 350 and less weld metal deposition than the AC waveform 320 which has a negative DC offset (see overlay weld metal 340′). It is assumed for discussion herein that the DC+/DC− balance of each of the AC waveforms 310 and 320 is 50/50. Therefore, it may be seen that more positive DC offset results in more penetration and less deposition, whereas more negative DC offset results in less penetration and more deposition.

When a weld metal is overlaid onto a substrate metal using, for example, an arc welding process, an admixture is formed which is a blending or mixture of the weld metal and the substrate metal. In general, the amount of admixture tends to increase as penetration increases and as deposition decreases. Such increased admixture results in a higher dilution of the overlaid weld metal with the substrate metal. Similarly, the amount of admixture tends to decrease as penetration decreases and as deposition increases. Such decreased admixture results in a lower dilution of the overlaid weld metal with the substrate metal.

Overlaying a weld metal onto a substrate or base metal is often done to protect the substrate metal from corrosion, heat, and/or wear. The resultant chemistry of the overlaid weld metal, not just the penetration and deposition, can be very important in determining how well the overlay will protect the base metal. The resultant chemistry of the overlaid weld metal depends on the materials that the weld metal and substrate metal are made of as well as the admixture of those materials resulting from the overlay welding process.

For example, when overlaying a nickel alloy metal onto a carbon steel substrate, a resultant chemistry of the overlay weld metal may correspond to a particular iron content of the resultant overlay weld metal or a particular ratio of iron content to nickel content of the resultant overlay weld metal. Similarly, when overlaying an austenitic stainless steel metal onto a carbon steel substrate, a resultant chemistry of the overlay weld metal may correspond to a particular ferrite number (FN) of the resultant overlay weld metal. The iron content, ratio of iron content to nickel content, and/or the FN may greatly affect how well the overlay metal protects the base metal against corrosion, heat, and/or wear. Ferrite number (FN) is defined as an arbitrary, standardized value designating the ferrite content of an austenitic stainless steel weld metal and may be used in place of percent ferrite or volume percent ferrite on a direct replacement basis.

For example, as penetration increases for an austenitic overlay on carbon steel, the chromium (Cr), nickel (Ni), and molybdenum (Mo) content decreases. As these concentrations of “ferrite formers” decrease, so does the FN. A low FN may increase the chance of hot cracking. A hot crack is a crack that develops during solidification and is undesirable.

In a particular overlaying welding process, a user typically works to a written specification that specifies an operating current (or a current range) and an operating voltage (or a voltage range) of an AC welding waveform (having a particular frequency) for the particular overlaying welding process. Such specified operating currents and voltages may correspond to constant current modes of operation and/or constant voltage modes of operation, for example.

A specified operating current and voltage for a particular AC welding waveform results in a certain deposited amount of wire per second or wire feed speed (WFS) defining a desired productivity for the overlay welding process. For certain overlay applications, a constant voltage mode of operation tends to provide a more stable WFS. Such a specified operating current and voltage for a particular AC welding waveform also results in a certain level of penetration desired for the overlay welding process, usually based on how much penetration is needed for the overlay weld metal to properly adhere to the base metal. Users are often required to follow such voltage and current specifications and not deviate from such specifications.

However, such specifications do not take into account a resultant chemistry of the overlay weld metal that is produced. Often, the resultant weld metal chemistry is not known and, therefore, may or may not be adequate to provide the desired protection or, at least, the resultant weld metal chemistry may not be optimal for the desired protection (e.g., corrosion resistance, heat resistance, wear resistance).

In accordance with an embodiment of the present invention, given a specified AC welding waveform (i.e., specified frequency, current, and voltage) to be used for overlaying a particular weld metal onto a particular substrate or base metal to achieve a desired penetration and productivity, the DC+/DC− balance and/or the DC offset of the specified AC welding waveform may be adjusted to provide a desired resultant optimal chemistry of the resultant overlay weld metal. The chemistry is affected by the DC+/DC− balance and the DC offset because, as described above, the balance and offset can affect dilution of the metals. Such dilution affects the resultant chemistry. Therefore, the resulting admixture and, therefore, chemistry may be affected by the settings of the balance and offset.

Therefore, a user may adhere to the required specifications for the overlay welding process but still adjust certain parameters (i.e., DC+/DC− balance and/or DC offset) of the AC welding waveform to achieve a desired (e.g., optimally protective) chemistry of the resultant overlay weld metal. In order to arrive at a desired chemistry for a resulting overlay weld metal, DC+/DC− balance settings and DC offset settings are correlated to resultant chemistries for a specified waveform for a particular overlay welding process, in accordance with an embodiment of the present invention.

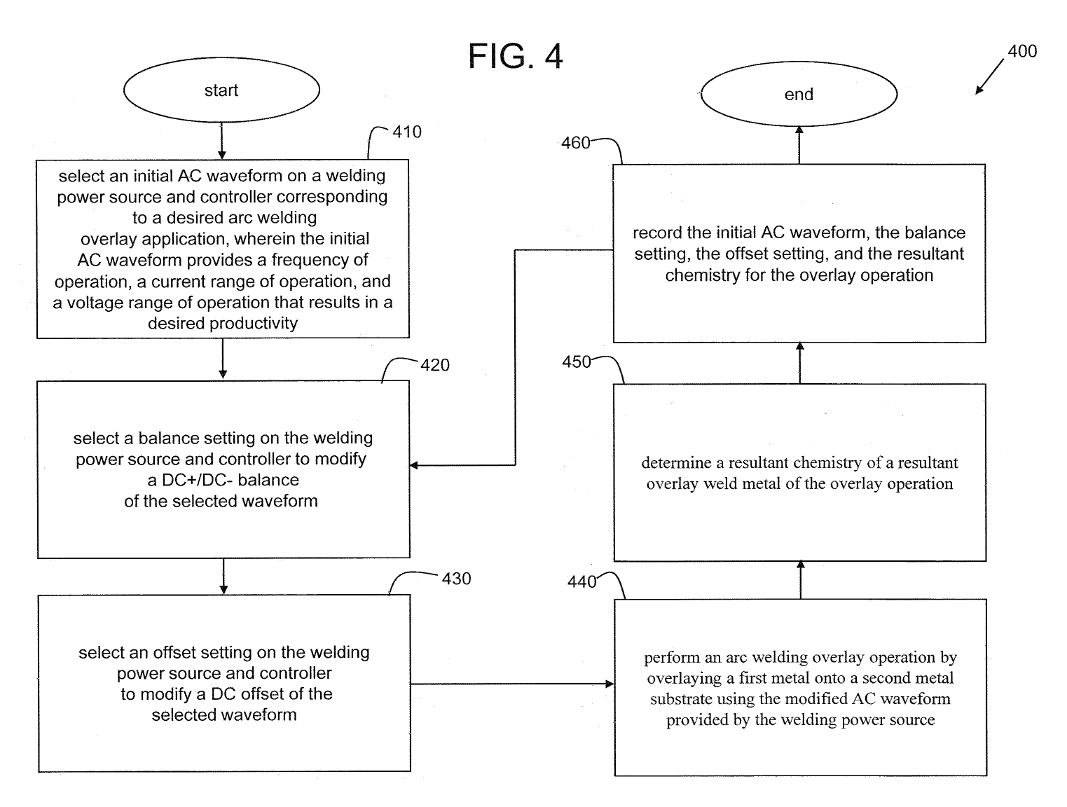

FIG. 4 is a flowchart of an exemplary embodiment of a method 400 to correlate welding power source and controller waveform parameters to a resultant weld metal chemistry in an arc welding overlay application. In step 410, select an initial AC waveform on a welding power source and controller corresponding to a desired arc welding overlay application, wherein the initial AC waveform provides a frequency of operation, a current range of operation, and a voltage range of operation that results in a desired productivity. In step 420, select a balance setting on the welding power source and controller to modify a DC+/DC− balance of the selected waveform. In step 430, select an offset setting on the welding power source and controller to modify a DC offset of the selected waveform.

In step 440, perform an arc welding overlay operation by overlaying a first metal onto a second metal substrate using the modified AC waveform provided by the welding power source and controller. In step 450, determine a resultant chemistry of a resultant overlay weld metal of the overlay operation. In step 460, record the initial AC waveform, the balance setting, the offset setting, and the resultant chemistry of the overlay operation. Repeat steps 420 to 460 for various combinations of balance and offset settings.

The recorded information, or at least a portion thereof, may be stored in the welding power source and controller 110, for example, such that a user may access the information to aid in selecting a combination of balance and offset to be applied to a selected AC waveform. Furthermore, the recorded information, or at least a portion thereof, may be programmed within the welding power source and controller 110 such that, when a particular AC welding waveform is selected for a particular arc welding overlay operation, a balance and offset combination correlated to a desired chemistry is automatically applied to the selected waveform.

The step of determining a resultant chemistry of a resultant overlay weld metal may involve, for example, cutting through the resultant overlay metal on the substrate metal to create a cross section and performing X-ray photoelectron spectroscopy which is well known in the art. Other methods of determining a resultant chemistry are possible as well such as, for example, atomic absorption spectroscopy which is well known in the art.

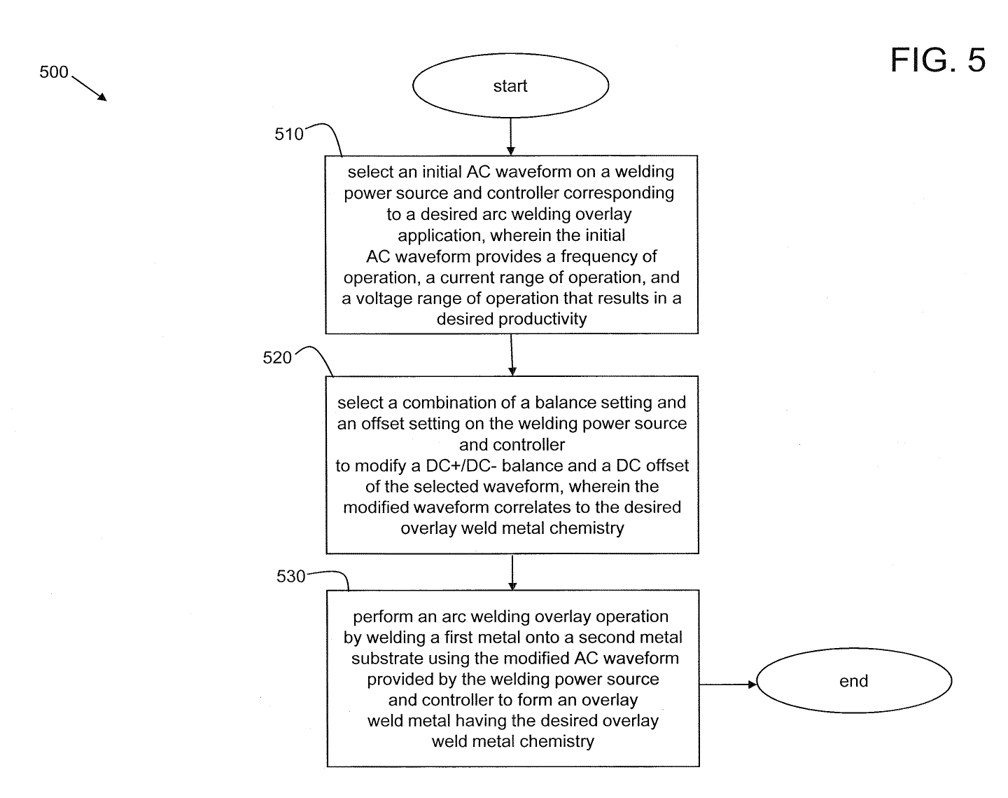

Once the correlation process is complete and the correlations are known, a user may then select a particular combination of DC+/DC− balance and DC offset to achieve a particular desired chemistry for a particular overlay process. FIG. 5 is a flowchart of an exemplary embodiment of a method 500 to perform an arc welding overlay operation to achieve a desired overlay weld metal chemistry. In step 510, select an initial AC waveform on a welding power source and controller corresponding to a desired arc welding overlay application, wherein the initial AC waveform provides a frequency of operation, a current range of operation, and a voltage range of operation that results in a desired productivity.

In step 520, select a combination of a balance setting and an offset setting on the welding power source and controller to modify a DC+/DC− balance and a DC offset of the selected waveform, wherein the modified waveform correlates to a desired overlay weld metal chemistry. In step 530, perform an arc welding overlay operation by welding a first metal onto a second metal substrate using the modified AC waveform provided by the welding power source and controller to form an overlay weld metal having the desired overlay weld metal chemistry.

As an example, when overlaying a nickel alloy metal onto a carbon steel substrate, it may be desirable to achieve an overlay weld chemistry having a predefined maximum iron content and a predefined minimum nickel content. As long as the iron content does not rise above the predefined maximum and as long as the nickel content does not fall below the predefined minimum, the resultant weld chemistry may provide acceptable resistance to corrosion, for example. It may be found through experimentation that, for a particular specified AC SAW waveform, a DC+/DC− balance of 65%/35% and a negative DC offset of −10% provides the desired chemistry.

In hard-facing applications, it may be desirable to control admixture. To minimize dilution/admixture with the base material, two or three hard-facing layers may be applied. In theory, the chemistry of the final layer should match the chemistry of the hard-facing electrode (i.e., little or no admixture from the base material). However, this is problematic when welding chromium carbide overlay where spalling is an issue and, therefore, no more than two layers are typically applied. The result is more dilution than desired. Spalling is the breaking of weld metal particles away from the base metal or underlying hardsurfacing layers. The broken pieces may vary in size from small chips to large chunks that expose the base metal. However, applying the techniques herein by adjusting waveform balance and offset may allow richer deposits on carbon based steel. Similar to chromium carbide deposits, manganese deposits may be better controlled by applying the techniques herein of adjusting waveform balance and offset.

In summary, a system and methods for overlaying metal in an arc welding operation to achieve a resultant weld metal chemistry of the resultant weld metal are disclosed. Various combinations of DC+/DC− balance settings and DC offset settings for an AC Waveform of an arc welding overlaying process may be correlated to resultant chemistries of resultant weld metals. The correlations may be subsequently used to select a combination of a balance setting and an offset setting for an AC waveform that results in a desired weld metal chemistry for an arc welding overlaying process using an overlay metal and a base substrate metal.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

What is claimed is:

1. A method to correlate welding power source and controller waveform parameters to a resultant weld metal chemistry in an arc welding overlay application, said method comprising:
(a) selecting an initial AC waveform on a welding power source and controller corresponding to a desired arc welding overlay application, wherein said initial AC waveform provides a frequency of operation, a current range of operation, and a voltage range of operation that results in a desired productivity;
(b) selecting a balance setting on said welding power source and controller to modify a DC+/DC− balance of said selected waveform;
(c) selecting an offset setting on said welding power source and controller to modify a DC offset of said selected waveform;
(d) performing an arc welding overlay operation by overlaying a first metal onto a second metal substrate using said modified AC waveform provided by said welding power source and controller;
(e) determining a resultant chemistry of a resultant overlay weld metal of said overlay operation;
(f) recording said initial AC waveform, said balance setting, said offset setting, and said resultant chemistry for said overlay operation; and
(g) repeating steps (b) through (f) until all combinations of said balance setting and said offset setting have been used.

2. The method of claim 1 wherein said resultant chemistry corresponds to at least one of a particular iron content of said resultant overlay weld metal, a particular ratio of iron content to nickel content of said resultant overlay weld metal, a particular ferrite number (FN) of said resultant overlay weld metal, a particular chromium carbide content of said resultant overlay weld metal, and a particular manganese content of said resultant overlay weld metal.

3. The method of claim 1 wherein said first metal comprises a nickel alloy and said second metal substrate comprises carbon steel.

4. The method of claim 1 wherein said first metal comprises a nickel and chromium alloy and said second metal substrate comprises carbon steel.

5. The method of claim 1 wherein said first metal comprises an austenitic stainless steel and said second metal substrate comprises carbon steel.

6. The method of claim 1 wherein said arc welding overlay operation is a submerged arc welding (SAW) overlay operation.

7. A method to perform an arc welding overlay operation to achieve a desired overlay weld metal chemistry, said method comprising:
(a) selecting an initial AC waveform on a welding power source and controller corresponding to a desired arc welding overlay application, wherein said initial AC waveform provides a frequency of operation, a current range of operation, and a voltage range of operation that results in a desired productivity;
(b) selecting a combination of a balance setting and an offset setting on said welding power source and controller to modify a DC+/DC− balance and a DC offset of said selected waveform, wherein said modified waveform correlates to said desired overlay weld metal chemistry; and
(c) performing an arc welding overlay operation by welding a first metal onto a second metal substrate using said modified AC waveform provided by said welding power source and controller to form an overlay weld metal having said desired overlay weld metal chemistry.

8. The method of claim 7 wherein said desired overlay weld metal chemistry corresponds to at least one of a particular iron content of said resultant overlay weld metal, a particular ratio of iron content to nickel content of said resultant overlay weld metal, a particular ferrite number (bFN) of said resultant overlay weld metal, a particular chromium carbide content of said resultant overlay weld metal, and a particular manganese content of said resultant overlay weld metal.

9. The method of claim 7 wherein said first metal comprises a nickel alloy and said second metal substrate comprises carbon steel.

10. The method of claim 7 wherein said first metal comprises a nickel and chromium alloy and said second metal substrate comprises carbon steel.

11. The method of claim 7 wherein said first metal comprises an austenitic stainless steel and said second metal substrate comprises carbon steel.

12. The method of claim 7 wherein said arc welding overlay operation is a submerged arc welding (SAW) overlay operation.

13. An arc welding system, said system comprising:
means for directing a first metal electrode toward a second metal substrate during an arc welding overlay operation of overlaying said first metal electrode onto said second metal substrate;
means for supplying said first metal electrode to said means for directing said first metal electrode toward said second metal substrate at a selected wire feed speed during said arc welding overlay operation;
means for providing electrical power in the form of a selected arc welding AC waveform between said first metal electrode and said second metal substrate during said arc welding overlay operation to form an arc between said first metal electrode and said second metal substrate such that said selected arc welding AC waveform results in a desired productivity during the arc welding overlay operation; and
means for selecting and applying a combination of a DC+/DC− balance setting and a DC offset setting to said selected arc welding AC waveform, wherein said combination has been previously correlated to a specific chemistry of an overlay weld metal resulting from said arc welding overlay operation using said arc welding system.

14. The arc welding system of claim 13 wherein said specific chemistry of said resulting overlay weld metal corresponds to at least one of a particular iron content of said resultant overlay weld metal, a particular ratio of iron content to nickel content of said resultant overlay weld metal, a particular ferrite number (FN) of said resultant overlay weld metal, a particular chromium carbide content of said resultant overlay weld metal, and a particular manganese content of said resultant overlay weld metal.

15. The arc welding system of claim 13 wherein said specific chemistry of said resulting overlay weld metal corresponds to a particular ratio of iron content to nickel content.

16. The arc welding system of claim 13 wherein said specific chemistry of said resulting overlay weld metal corresponds to a particular ferrite number (FN).

17. The arc welding system of claim 13 wherein said first metal electrode comprises a nickel alloy and said second metal substrate comprises carbon steel.

18. The arc welding system of claim 13 wherein said first metal electrode comprises a nickel and chromium alloy and said second metal substrate comprises carbon steel.

19. The arc welding system of claim 13 wherein said first metal electrode comprises an austenitic stainless steel and said second metal substrate comprises carbon steel.

20. The arc welding system of claim 13 wherein said arc welding system is a submerged arc welding (SAW) system.
